(19) United States
(12) Patent Application Publication
(10) Pub. No.: US 2003/0140175 A1
(43) Pub. Date: Jul. 24, 2003

(54) PRIORITIZING JOB PROCESSING BASED ON JOB SOURCE

(76) Inventors: SCOTT D. BONAR, MERIDIAN, ID (US); D. LANCE SPAULDING, BOISE, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 09/385,663

(22) Filed: Aug. 26, 1999

(51) Int. Cl. G06F 9/46; G06F 9/00

(52) U.S. Cl. 709/314; 709/103

(57) ABSTRACT

A job is sent to a device for processing. The device includes a queue manager for determining the order in which jobs are processed. The queue manager receives the job and assigns the job a queue position. The queue position is alternatively computed either from a priority assigned to the job or the source of the job. The priority is alternatively assigned either by the queue manager based on the source of the job or by a device driver that sends the job to the device. A relative time or order that the job was received may also be used to compute the queue position.

### FIELD OF THE INVENTION

This invention relates in general to job processing in a job processing device and, more particularly, to prioritizing a job for processing based on the source of the job.

### BACKGROUND OF THE INVENTION

A printer communicating with a network, either directly or though a network server, is able to receive several print jobs from several different sources. In addition to receiving print jobs from the network, the printer may be able to receive print jobs through various ports of the printer.

A queue manager determines the order in which a print job is processed by the printer. Conventionally, each print job is placed in a print queue in the order the queue manager receives the job. Therefore, each print job is processed in the order the queue manager receives it.

While this first-in, first-out order in which jobs have been processed seems reasonable, it is often inconvenient in situations where a person must be physically present at the printer. For example, many printers now include infrared ports to allow a person to print a job from a laptop near the printer. Additionally, a printer may be physically coupled to a scanner in order to emulate photocopier functionality. In the two above examples, it is often more convenient and desirable for the job for the person physically at the printer to be processed ahead of other jobs queued for processing by the printer.

### SUMMARY OF THE INVENTION

According to principles of the present invention, a job is sent to a device for processing. The device includes a queue manager for determining the order in which jobs are processed. The queue manager receives the job and assigns the job a queue position. The queue position is alternatively computed either from a priority assigned to the job or the source of the job. The priority is alternatively assigned either by the queue manager based on the source of the job or by a device driver that sends the job to the device.

According to further principles of the present invention, a relative time or order that the job was received may also be used to compute the queue position.

Other objects, advantages, and capabilities of the present invention will become more apparent as the description proceeds.

### DESCRIPTION OF THE DRAWINGS

FIG. 1 is a block diagram illustrating a system for practicing the present invention.

FIG. 2 is a flow chart illustrating one embodiment of the method of the present invention.

FIG. 3 is a flow chart illustrating an alternate embodiment of the method of the present invention.

### DETAILED DESCRIPTION OF THE INVENTION

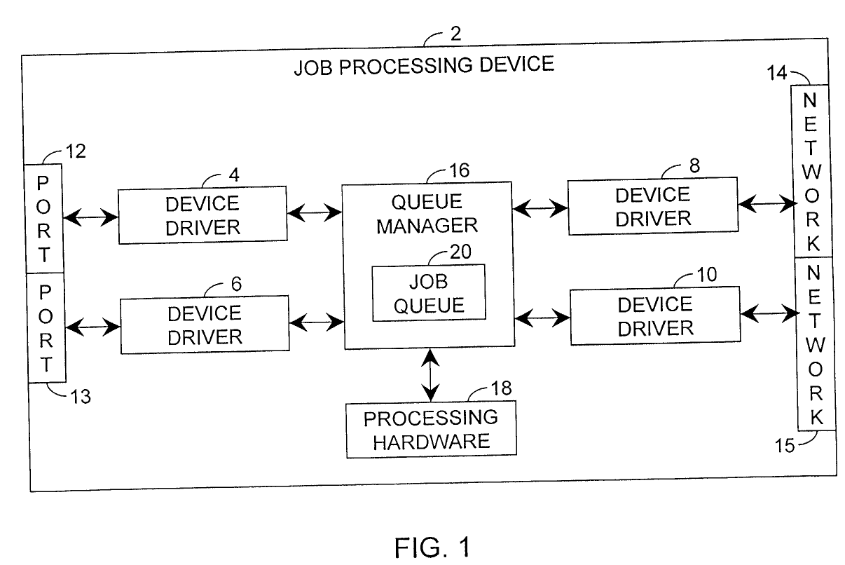

Illustrated in FIG. 1 is a job processing device 2. Job processing device 2 includes device drivers 4,6,8,10; ports 12,13; network connections 14,15; a queue manager 16; and processing hardware 18. Job processing device 2 is any device having a queue manager 16 that is capable of receiving and processing a job. Printers and plotters are examples of job processing devices 2.

Processing hardware 18 is the mechanism that processes the job. For a printer, processing hardware 18 is the mechanism that outputs the job to the print media.

Ports 12,13 and network connections 14,15 receive jobs for processing by job processing device 2. Device drivers 4,6 communicate with ports 12,13 respectively. Similarly, device drivers 8,10 communicate with network connections 14,15 respectively. Jobs received by ports 12,13 and network connections 14,15 are communicated by device drivers 4,6,8,10 to queue manager 16.

Although FIG. 1 illustrates four device drivers 4,6,8,10, any number of device drivers 4,6,8,10 may be included in the present invention. For clarity, only four device drivers 4,6,8,10 are shown in FIG. 1. Each device driver 4,6,8,10 communicates jobs from an external source to queue manager 16. Device drivers 4,6,8,10 are able to identify through which type of connection a job was communicated to job processing device 2. The connection type is the port 12,13 or network connection 15,16. Ports 12,13 are any type of port connection. For example, ports 12,13 may be parallel ports, an infrared ports, or serial ports. Ports 12,13 need not be the same type of port.

Queue manager 16 communicates with device drivers 4,6,8,10 and processing hardware 18. All jobs received by job processing device 2 are also received by queue manager 16. Queue manager 16 is able to recognize through which type of connection the job was communicated to job processing device 2. Queue manager 16 may also be able to recognize a relative time a job was received. The relative time is either a chronological time or an order in which the job was received relative to other jobs received by queue manager 16.

Queue manager 16 maintains a job queue 20. Job queue 20 is shown as residing within queue manager 16, but alternatively resides outside of queue manager 16. Job queue 20 is list of the jobs pending to be processed by processing hardware 18. Each of the jobs in job queue 20 has a position within job queue 20 that will be referred to as a queue position. The queue position is the order in which processing hardware 18 will process each pending job. The queue position for each job is controlled by queue manager 16. Queue manager 16 initially selects a queue position for each job received by job processing device 2. Queue manager 16 may also change the queue position for each job in job queue 20.

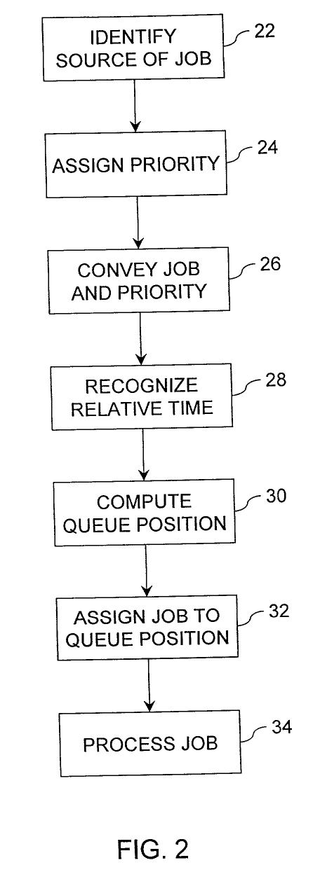

FIG. 2 illustrates one embodiment of a method of the present invention. Although FIG. 2 presents method steps in a specific order, the steps may be carried out in any order that will accomplish the present invention. Although the print job may be communicated to queue manager 16 through any of the device drivers 4, 6, 8, 10, the steps illustrated in FIG. 2 will be described for device driver 4 only. The steps are the same for a job communicated to queue manager 16 through the other drivers.

A job is received by job processing device 2 through port 12. In one embodiment, device driver 4 identifies 22 the source of the print job. The source of the job is the path through which the job was communicated to job processing device 2. Therefore, the source for a job passing through device driver 4 is port 12. In an alternate embodiment, step 22 is omitted.

Device driver 4 assigns 24 a priority to the job. The priority assigned to the job is based on the source of the job in one embodiment and on any other criteria in another embodiment. The priority may also be based both on the source of the job and on other criteria.

The job and the priority are then conveyed 26 to queue manager 16. Queue manager 16 receives the job and in one embodiment recognizes 28 the relative time the job was received. In another embodiment, step 28 is omitted.

Queue manager 16 then computes 30 a queue position for the job. Queue manager 16 determines the queue position for the job by comparing the priority of the job to the priority of other jobs in job queue 20. The queue position of the job is the next position after other jobs in job queue 20 having the same priority as the job. If no other jobs in job queue 20 have the same priority as the job, the queue position for the job is the position before the first not yet started job in job queue 20 having a lower priority than the job. If no other job in job queue 20 has a lower priority than the job, the queue position of the job is the next position after the last job in job queue 20 having a higher priority than the job.

In one embodiment, queue manager 16 also uses the relative time the job was received by queue manager 16 when computing 30 the queue position. In an alternate embodiment, queue manager 16 does not use the relative time the job was received by queue manager 16 when computing 30 the queue position.

Once the queue position within job queue is computed 30, the job is assigned 32 the computed queue position. The job is then processed 34 by processing hardware 18 according to the queue position of the job. Jobs positioned sooner in job queue 20 are processed by processing hardware 18 sooner than jobs positioned later in job queue 20.

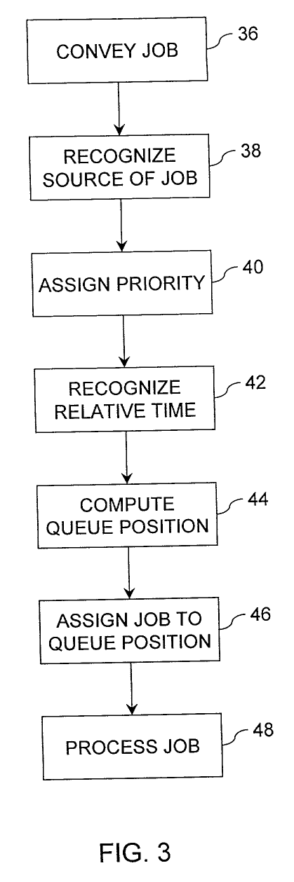

FIG. 3 illustrates an alternate embodiment to the embodiment illustrated in FIG. 2 for the method of the present invention. Although FIG. 3 presents method steps in a specific order, the steps may be carried out in any order that will accomplish the present invention. Although the print job may be communicated to job processing device 2 through any of the ports 12, 13 or network connections 15, 16, the steps illustrated in FIG. 3 will be described for port 12 only. The steps are the same for a job communicated to job processing device 2 through other ports and network connections.

The job is conveyed 36 to job processing device 2 through port 12. Queue manager 16 receives the job for job processing device 2 and recognizes 38 the source of the print job.

In one embodiment, queue manager 16 assigns 40 a priority to the job. The priority assigned to the job is based on the source of the job in one embodiment and on any other criteria in another embodiment. The priority may also be based both on the source of the job and on other criteria. In an alternate embodiment, step 40 is omitted.

In one embodiment queue manager 16 also recognizes 42 the relative time the job was received. In another embodiment step 42 is omitted.

Queue manager 16 then computes 44 a queue position for the job. When a priority has been assigned to the job, queue manager 16 determines the queue position for the job just as in the embodiment illustrated by FIG. 2. When no priority has been assigned to the job, the queue position is determined by comparing the source of the job to the sources of the other jobs in job queue 20. Jobs from selected sources are given more immediate queue positions than jobs from other sources. For example, jobs from an infrared port are given more immediate queue positions than jobs from a network connection.

In one embodiment, queue manager 16 also uses the relative time the job was received by queue manager 16 when computing 44 the queue position. In an alternate embodiment, queue manager 16 does not use the relative time the job was received by queue manager 16 when computing 44 the queue position.

Once the queue position with job queue is computed 44, the job is assigned 46 to the computed queue position. The job is then processed 48 by processing hardware 18 according to the queue position of the job. Jobs positioned sooner in job queue 20 are processed by processing hardware 18 sooner than jobs positioned later in job queue 20.

It should be understood that the foregoing description is only illustrative of the invention. Various alternatives and modifications can be devised by those skilled in the art without departing from the invention. Accordingly, the present invention is intended to embrace all such alternatives, modifications and variances that fall within the scope of the appended claims.

What is claimed is:

1. A method for prioritizing a job for processing on a device, the method comprising:
(a) assigning a priority to the job;
(b) conveying the job and the assigned priority to a queue manager for the device;
(c) the queue manager computing a queue position for the job from the priority assigned to the job;
(d) assigning the job to the queue position; and,
(e) processing the job on the device according to the position of the job in the job queue.

2. The method of claim 1 wherein assigning the priority to the job includes:
(a) identifying a source of the job; and,
(b) assigning the priority based on the source of the job.

3. The method of claim 1 further including recognizing a relative time the job was conveyed to the queue manager and wherein the queue position is further computed from the relative time.

4. The method of claim 1 wherein assigning the priority to the job includes a device driver assigning the priority to the job.

5. The method of claim 1 wherein conveying the job and the assigned priority to the queue manager includes a device driver conveying the job and the assigned priority to the queue manager.

6. The method of claim 1 wherein conveying the job and the assigned priority includes conveying the job and the assigned priority through a port of the device.

7. A method for prioritizing a job for processing on a device, the method comprising:
(a) conveying the job to a queue manager;
(b) the queue manager recognizing a source of the job;
(c) the queue manager computing a queue position for the job from the source of the job;
(d) assigning the job to the queue position; and,
(e) processing the job according to the position of the job in the job queue.

8. The method of claim 7 wherein computing a queue position for the job includes:
(a) assigning a priority to the job based on the source of the job; and,
(b) computing the queue position from the priority.

9. The method of claim 7 further including recognizing a relative time the job was conveyed to the queue manager and wherein the queue position is further computed from the relative time.

10. The method of claim 7 wherein conveying the job to the queue manager includes a device driver conveying the job to the queue manager.

11. The method of claim 7 wherein conveying the job includes conveying the job through a port of the device.

12. A system for prioritizing a job for processing on a device, the system comprising:
(a) a queue manager including:
(i) means for computing a queue position for the job from a priority assigned to the job and
(ii) means for assigning the job to the queue position;
(b) a device driver for conveying the job to the queue manager; and,
(c) means for processing the job according to the position of the job in the job queue.

13. The system of claim 12 wherein the device driver includes means for assigning the priority to the job.

14. The system of claim 13 wherein the device driver further includes means for identifying a source of the job and wherein the means for assigning the priority to the job includes means for assigning the priority to the job based on the source of the job.

15. The system of claim 14 wherein the source of the job includes a port interconnecting the queue manager and the device driver.

16. The system of claim 12 wherein the queue manager further includes:
(a) means for recognizing a source of the job; and,
(b) means for assigning a priority to the job based on the source of the job.

17. The system of claim 16 wherein the source of the job includes a port interconnecting the queue manager and the device driver.

18. The system of claim 12 further including means for recognizing a relative time the job was conveyed to the queue manager and wherein the means for computing the queue position for the job includes means for computing the queue position from the relative time.
